(19) United States
(12) Patent Application Publication
(10) Pub. No.: US 2007/0224483 A1
(43) Pub. Date: Sep. 27, 2007

(54) Presursor Organic of Tetravalent Metal Phosphates and Pyrophosphates and Their Use for Electrode Modification and for the Preparation of Composite Membrane for Fuel Cells Working at Temperatures>90c and / or at Low Relative Humidity

(76) Inventors: Giulio Alberti, Perugia (IT); Monica Pica, Gaulda Tadino (IT); Tiziano Tarpanelli, S. Maria Degli Angeli-Assisi (IT)

Correspondence Address: NATH & ASSOCIATES, 112 South West Street, Alexandria, VA, 22314, US

(21) Appl. No.: 11/579,146

(22) PCT Filed: Aug. 18, 2004
(86) PCT No.: PCT/EP04/09262

§ 371 Date: Dec. 21, 2006

(30) Foreign Application Priority Data
Apr. 30, 2004 (IT) PG2004A0013

(51) Int. Cl. C01B 25/37; B01D 71/02; C01B 25/42; H01M 8/00; H01G 9/00; B01J 27/16

(52) U.S. Cl. 429/33; 423/307

(57) ABSTRACT

The invention is based on the preparation of precursor organic solutions of tetravalent metal phosphates and pyrophosphates with composition M(IV)(O₃P—H)₂, M(IV)[O₂P(OH)₂]₂[O₂PO(OH)] and M(IV)P₂O₇(M=Zr, Hf, Ti). An important property of these solutions is that the said compounds are formed when the solvent is evaporated. This peculiarity allows an easy insertion of the compounds inside the pores of porous membranes, in polymeric membranes and in the electrodic interfaces of fuel cells. The acid properties of their surfaces, the high thermal stability and the insolubility in water make these particles extremely of interest for improving the efficiency of PEMFCs in the temperature range 90-130° C. The peculiar characteristics of non-water assisted proton conductivity of M(IV)[O₂P(OH)₂]₂[O₂PO(OH)] compounds open new prospects for their application in PEMFCs at low relative humidity.

The interest for polymeric electrolyte fuel cells (PEMFC) is considerably grown since these electrochemical generators do not produce fine particles or toxic gases and, furthermore have a better performance than thermal motors.

A massive replacement of the present vehicles with new electrical vehicles supplied by fuel cells is expected to have a beneficial effect not only on the air pollution of large towns but also could slow down the present fuel burning speed, thus decreasing also the danger due to sun house effects.

In spite of research efforts in all the most industrialized nations, the mass production of PEMFC electrical vehicles is hindered by various problems, especially related to the efficiency of the state of the art of electrodes, that have not yet the requested exchange currents, and to the proton conducting membranes of the state of the art, which do yet possess high proton conductivity when working at low relative humidity.

Even when very expensive platinum electrodes and the best presently available perfluorosolfonic membranes are used, PEMFCs dramatically decrease their performance at temperatures greater than 90° C. and at relative humidity lower than 70%. In practice, the present PEMFCs for cars are obliged to operate in the temperature range 70-90° C. and at relative humidity greater than 75%, thus making complicate and expensive either the cooling of the cells, especially in summer, or the water management.

In a previous patent it has been shown that the presence of inorganic particles in the interfacial electrodes/membrane regions considerably improves the performance of PEMFCs at temperatures greater than 100° C. (G. Alberti et al. EP1205994)

This important result has been later confirmed also by American researchers (L. Krishnan et al. Abstracts of 201st Meeting of ECS, Philadelphia May 12-17, 2002).

It has been reported in literature (see, as an example, the recent review of G. Alberti, M. Casciola, Annu. Rev. Res. 2003, 33:129 and references therein) that an improvement of PEMFCs performance at temperatures greater than 90° C. can be obtained by insertion of inorganic nano-particles in the polymeric matrix of the membranes used in these devices.

Thus, the facility and economy of the insertion of inorganic particles in the electrodes/membrane interfacial regions and/or inside ionomeric membranes of the state of the art assumes a relevant importance for commercial developments of PEMFCs.

Such insertion is not easy to be performed since the inorganic particles to be inserted must be preferably very insoluble in water and in common organic solvents and they have furthermore very low vapour pressures.

A very promising procedure for these insertions is based on the possibility of preparing organic solutions containing the components of the inorganic particles to be inserted.

Such solutions must preferably have the property that the insoluble particles are formed only when the solvent is eliminated, eventually after a thermal treatment. These solutions can therefore be considered as soluble precursors of insoluble inorganic particles

A large part of the inorganic particles already inserted in ionomeric membranes are based on silica or metal oxides such as titania and zirconia usually obtained for decomposition with water of the corresponding metal alcoxides (A. S. Aricò, V. Antonucci, 1999, EP 0926754; Roziere et al., WO0205370).

Recently, the preparation of precursor organic solutions of tetravalent metal phosphate-sulfophenylenphosphonates having compositions M(IV)(O₃P-G)₂₋ₓ(O₃P—Ar—SO₃H)ₓ, where G is a generic organic or inorganic radical, Ar is an arylenic radical, has been reported (G. Alberti et al. WO 03/081691 A2).

The lamellar tetravalent metal phosphates such as zirconium phosphate Zr(O₃P—OH)₂, are of interest for the acid surface of the lamellae; therefore, they have been inserted, with very promising results, in membranes for medium temperature fuel cells (P. Costamagna et al., 2002, Electrochimica Acta 47:1023; M. Yamashita et al. Abstracts of the 201st Meeting of ECS, Philadelphia May 12-17, 2002; B. Bauer et al. WO 03/077340 A2).

In this case, since the precursor organic solutions of zirconium phosphate were yet unknown, the insertion has been performed with more complicated procedures. In the patent WO 96/29752 the “in situ” precipitation has been used. The membrane is first contacted with a solution containing a zirconyl salt in order to obtain the replacement of protons of —SO₃H groups by ion exchange with zirconium. Then, by contacting the membrane with phosphoric acid the —SO₃H is regenerated and “in situ” precipitation of zirconium phosphate is obtained. Thus, this method requires the presence of acid groups in the polymer to be modified. In the patent WO 03/077340 A2, after an exfoliation process of Zr(O₃P—OH)₂ with amines, gels of said compound in organic solvents can be prepared. These gels are then dispersed in organic solution of ionomers. This procedure cannot be used for the filling of pre-formed porous membranes since the lamellar particles cannot enter inside small pores and they therefore remain on the external surface of the porous membrane.

Recently it was surprisingly found that precursor organic solutions of lamellar tetravalent metals acid phosphates can be also prepared, thus making possible an easier insertion in the matrix of ionomeric membranes, inside the pores of porous membranes and deposition on the catalytic surfaces of the electrodes.

A detailed investigation on the stability of these solutions showed that the stability can be increased: a) by increasing the basicity of the organic solvent (this property can be easily deduced from its K_{b} value); b) by decreasing the temperature; c) by increasing the [phosphoric acid]/[M(IV)] ratio.

The said precursor solutions can be prepared with different [phosphoric acid]/[M(IV)] ratio. In the case in which this ratio is exactly two, only M(IV)(O₃P—OH)₂ is obtained when the solvent is eliminated. However, it can be pointed out that in some cases the use of [phosphoric acid]/[M(IV)] ratios greater than two could be convenient since the stability of precursor solutions is increased.

Obviously, an excess of phosphoric acid remains after the solvent evaporation and it must be eliminated (e.g., by washing with a suitable solvent).

These important results convinced us to attempt the preparation of precursor solutions also for the three-dimensional acid phosphates such as M(IV)[O₂P(OH)₂]₂[O₂PO(OH)].

This class of phosphates has been only recently discovered (G. Alberti et al. It Patent. PG 2003 A 000005) and it is of great interest since all the examined compounds exhibit very high proton conductivity (1-3×10⁻² Scm⁻¹a 100° C.) even at very low (<1%) relative humidity.

Also in this case it was possible to find the conditions in which stable precursor solutions are formed. Thus, this discovery makes not only possible an easy insertion of said compounds in the interfacial electrodes/membrane regions and inside ionomeric membrane of the state of art, but also permits their insertion inside the pores of ceramic or polymeric membranes, thus enlarging in significant manner their potential applications. Of particular interest is their insertion inside polybenzoimidazole membranes (PBI) where the three-dimensional acid phosphates can partially or completely replace the phosphoric acid. Finally, an investigation on the thermal stability of said compounds showed that cubic pyrophosphates, M(IV)P₂O₇, are formed at temperatures greater than 120°-130° C. Due to their insolubility, high thermal and chemical stability as well as for their acid surfaces, M(IV)P₂O₇ particles can be used for the modification of electrodes and membranes of medium temperature PEMFCs.

Due to the thermal stability of pyrophosphates, the solvent can be eliminated also at high temperatures. Thus, even solvent with high boiling point can be used for the preparation of precursor solutions of M(IV)P₂O₇.

Precursor solutions of tetravalent metal pyrophosphates are particularly suitable for filling porous ceramic membranes to be used at high temperature.

It is an object of the present invention the preparation of a variety of organic solutions containing tetravalent metal salts and phosphoric acid that, at room temperature or lower, do not give place to gelations o precipitations for a sufficiently long time (at least one hour) in order to permit the use reported in the description and the claims and from which, for evaporation of the solvent it can be possible the direct preparation of insoluble compounds of composition Zr(O₃P—OH)₂, M(IV)[O₂P(OH)₂]₂ [O₂PO(OH)]e M(IV)P₂O₇ with cubic structure. However in other cases gels may be preferred.

It is a further object of the present invention for obtaining an easy filling of the pores of porous membranes either of polymeric or ceramic type.

It is a further object of the present invention the use of said solutions for obtaining an easy insertion of nano-particles of said compounds inside the matrix of organic or inorganic polymers provided that they are soluble in the same solvents.

The use can be extended also to polymers soluble in solvents different from those of the organic solutions object of the present invention, provided that they are mixable with said organic solutions and do not provoke a fast gelation of the solution or the precipitation of the compound to be dispersed in the polymeric matrix.

It is a further object of the present invention the use of said solutions for obtaining an easy insertion of said nano-particles in the electrodes/membrane interfaces of PEMFCs, either as pure compounds or in mixture with proton conducting ionomers such as Nafion and sulfonated PEK.

The following examples have the purpose of facilitating the understanding of the invention, and do not intend to limit in any manner its scope, which is solely defined by the appended claims.

The organic solutions and organic gels of the M(IV) compounds normally contain only one compound. However, mixtures of different compounds are possible.

### EXAMPLES

### Example 1

This example illustrates the detailed preparation of a DMF solution containing a zirconyl salt and phosphoric acid from which zirconium phosphate of α-type is obtained. Some data on the stability of these solutions are also reported.

8.7 g of anhydrous zirconyl propionate (Magnesium Elektron Limited, England) are dissolved in 40 mL of DMF. Taking into account that the composition of this compound was found to be ZrO_{1.27}(CH₃CH₂COO)_{1.46} (MW=217.9 Dalton), the above amount corresponds to 0.04 mol.

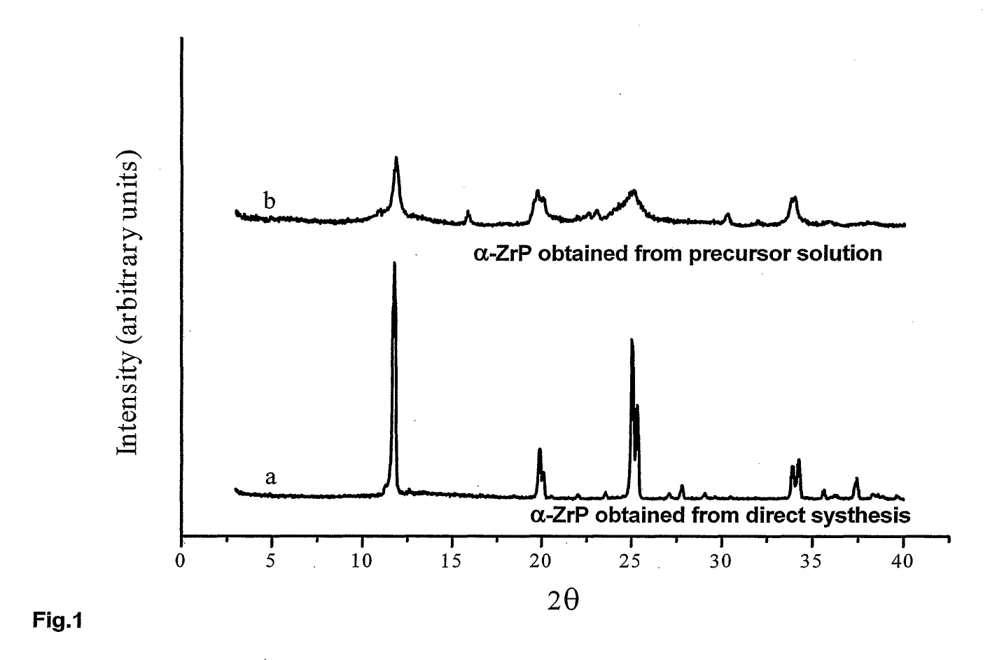

Separately, 0.08 mol of anhydrous phosphoric acid (7.84 g) are dissolved in 40 mL of DMF. The former solution is slowly added, under stirring at room temperature, to the last solution. A clear solution is obtained ([Zr(IV)]=0.5M). When the solution is warmed at 80° C., the formation of a compact and transparent gel is observed (the gel is usually formed in less than 30 minutes). The solid obtained after evaporation of the solent at 80 and 140° C. does not contain, as shown by ¹H NMR measurements, appreciable amount of propionates, but the presence of DMF is still evident. When the solid is washed with HCl 1M, a solid of composiion Zr(OH)_{0.6}(O₃POH)_{1.7} is obtained The X-ray powder diffraction pattern shows the peaks of zirconium phosphate with a layered structure of α-type (compare curves a and b of FIG. 1). From the titration curve an amount of acid phospates of 5.8 meq/g is obtained.

### Example 1bis

This example illustrates the detailed preparation of an DMF solution containing hafnium oxide chloride propionate and phosphoric acid from which hafnium phosphate of α-type is obtained. Some data on the stability of these solutions are also reported.

A mixed hafnium (IV) oxide chloride propionate used in this example was prepared in laboratory. A weighted amount of HfOCl₂.8H₂O (Strem Chemicals) and propionic acid (Aldrich) are mixed in a glass open vessel in the molar ratio 1:3. The mixture is kept under stirring at 60° C. by using an oil bath in order to obtain a solid residue. Chemical analysis showed that the anhydrous solid has the composition HfOCl_{0.64}(CH₃CH₂COO)_{1.36} (MW=317.2 Dalton).

12.7 g of the above compound (corresponding to 0.04 mol of Hf, previously dehydrated at 100° C. for 30 minutes) are dissolved in 40 mL of DMF. Separately, 0.08 mol of anhydrous phosphoric acid (7.84 g) are dissolved in 40 mL of DMF. The former solution is slowly added, under stirring at room temperature, to the last solution. A clear solution is obtained ([Hf(IV)]=0.5M). When the solution is warmed at 80° C., the formation of a compact and transparent gel is observed after about 30 minutes. The solid obtained after evaporation of the solvent at 80 and 140° C. for about 2 hours does not contain, as shown by ¹H NMR measurements, appreciable amount of propionates, but the presence of DMF is still evident. After washing with HCl 1M, a solid with a molar ratio [phosphate mol]/[Hf mol]=1.9 is obtained

### Example 1 tris

This example illustrates the detailed preparation of a DMF solution containing a titanium salt and phosphoric acid from which titanium phosphate of α-type is obtained. Some data of the stability of these solutions are also reported.

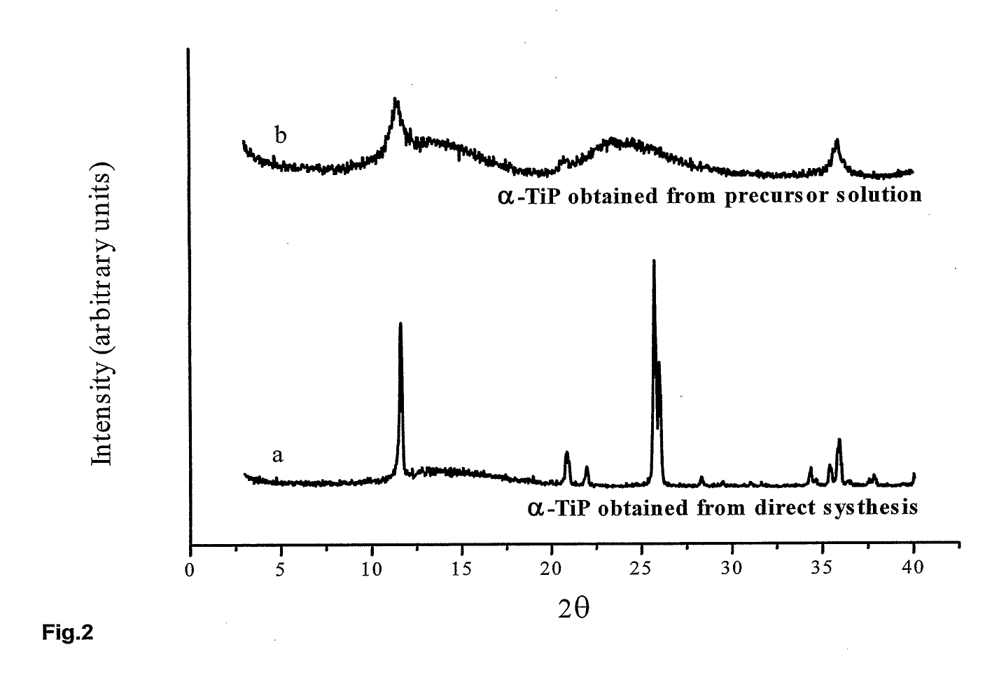

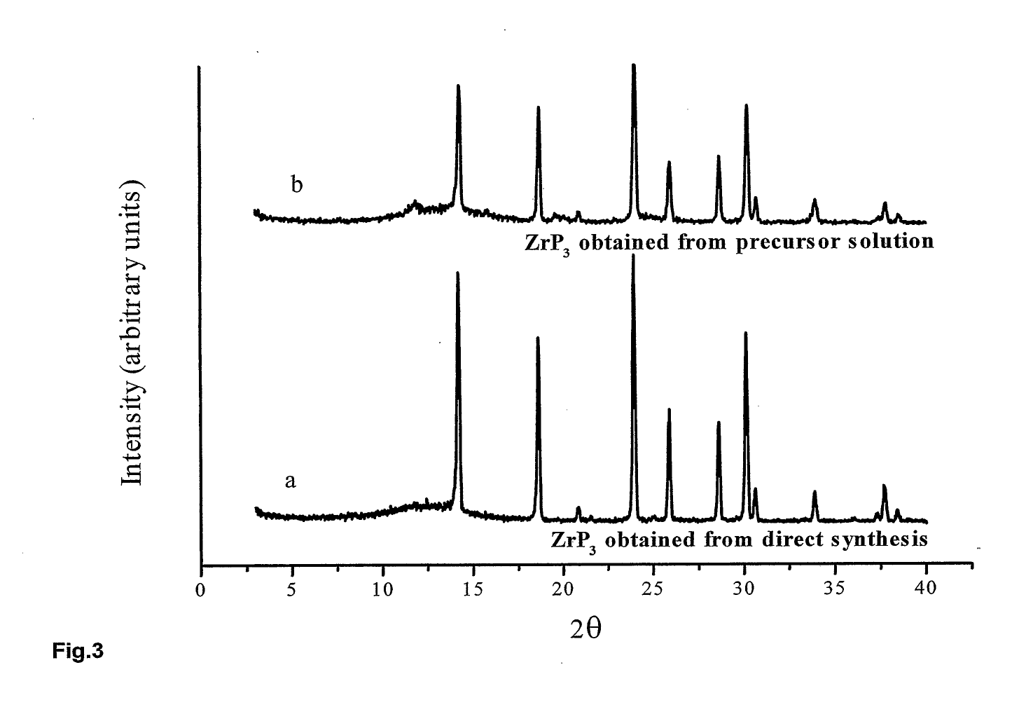

0.08 mol of anhydrous phosphoric acid (7.84 g) are dissolved in 68 mL of isobutanol. 11.36 g of titanium propoxide (98%, Aldrich), Ti(OCH₂CH₂CH₃)₄ ((MW=284 Dalton), corresponding to 0.04 mol, are added under stirring to the solution of the phosphoric acid, obtaining a clear solution ([Ti(IV)]=0.1M). When the solution is warmed at 80° C., the formation of a compact and transparent gel is observed (it takes usually less than 30 minutes). The X-ray powder diffraction pattern shows the peaks of semicrystalline titanium phosphate with a layered strutcture of α-type (compare curves a and b of FIG. 2). Chemical analysis showed that in the solid the molar ratio [phosphate mol]/[Ti mol] is 1.7±0.1.

### Example 2

This example illustrates the detailed preparation of a 3-hexanol solution containing a zirconyl salt and phosphoric acid from which zirconium phosphate of composition Zr[O₂P(OH)₂]₂[O₂PO(OH)], ZrP₃ is obtained. Some data on the stability of these solutions are also reported.

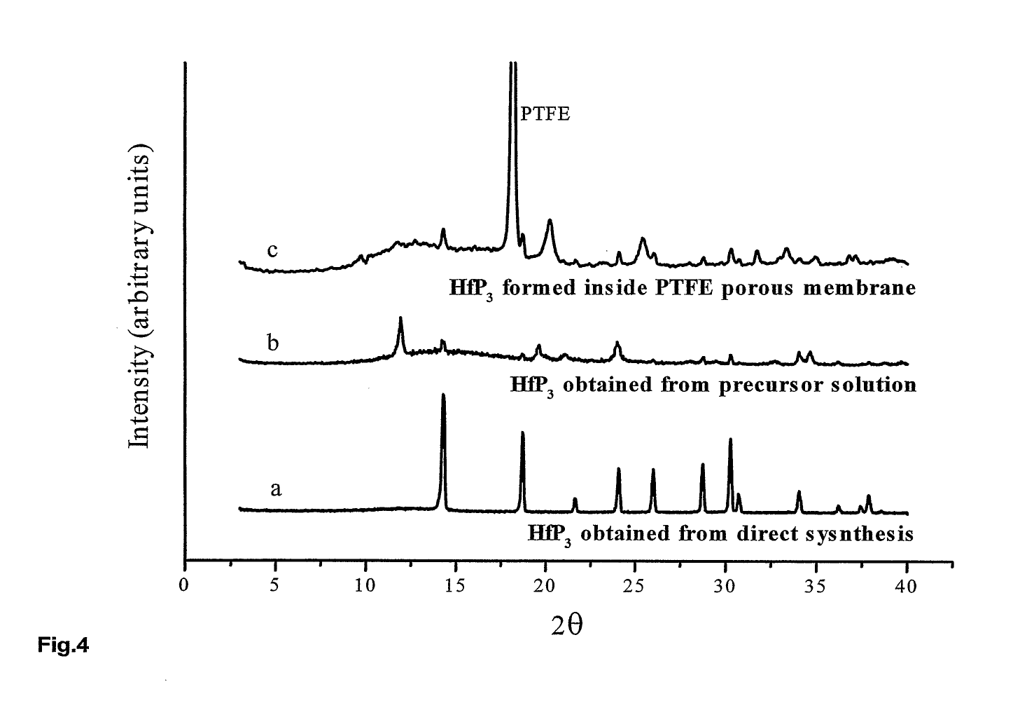

According to a procedure analogous to that described in examples 1-1tris, 0.008 mol of anhydrous zirconyl propionate (1.74 g) are dissolved in 40 mL of 3-hexanol while 0.024 mol of anhydrous phosphoric acid (2.35 g) are dissolved in 40 mL of 3-hexanol. The solution of phosphohric acid is then slowly added at 0° C. and under stirring to the solution of zirconyl propionate ([Zr]=0.1M). The behaviour of the obtained solution at temperatures >80° C. is very similar to that of the solution described in examples 1-1tris. Solvent evaporation at 80° C. leaves a residue which, as shows the X-ray powder diffraction pattern, has a layered structure of α-type (see FIG. 1, curve b). If the solid is left at 80-90° C., the gradual conversion into the phase Zr[O₂P(OH)₂]₂[O₂PO(OH)] and the disappearance of the α-phase is observed. The X-ray powder diffraction pattern obtained after two days of thermal treatment at 80° C. is reported in FIG. 4, curve b.

### Example 2 bis

This example illustrates the detailed preparation of a 3-hexanol solution containing hafnium oxide dichloride and phosphoric acid from which hafnium phosphate of composition Hf[O₂P(OH)₂]₂[O₂PO(OH)], HfP₃ is obtained. Some data of the stability of these solutions are also reported.

0.41 g of HfOCl₂ (1.53×10⁻³ mol of Hf obtained from dehydration at 100° C. for 30 minutes of Hafnium (IV) oxide dichloride octahydrate supplied by Strem Chemicals) are dissolved in 3 mL of 1-propanol. About 75% of propanol is evaporated and then 3-hexanol is added until the volume is 7.8 mL.

Separately 0.46 g of anhydrous phosphoric acid (4.68×10⁻³ mol) are dissolved in 7.8 mL of 3-hexanol. The solution of phosphoric acid is then slowly added, at 0° C. and under stirring, to the solution of hafnium oxide dichloride. A clear solution is obtained. The behaviour of the obtained solution at temperatures >80° C. is very similar to that of the solution described in example 1. Solvent evaporation at 80° C. leaves a residue which, as shown the X-ray powder diffraction pattern, has the structure of a hafnium phosphate of α-type (see FIG. 2, curve a). If the solid is left at a temperature of 80-90° C., a gradual conversion into the phase Hf[O₂P(OH)₂]₂[O₂PO(OH)], and the disappearance of the layered α-phase, is observed. The X-ray powder diffraction pattern obtained after 12 days of thermal treatment at 80° C. is reported in FIG. 4, curve b.

### Example 3

This example illustrates the detailed preparation of a 3-hexanol solution containing an zirconyl salt and phosphoric acid from which zirconium pyrophosphate of composition ZrP₂O₇ is obtained. Some data on the stability of these solutions are also reported.

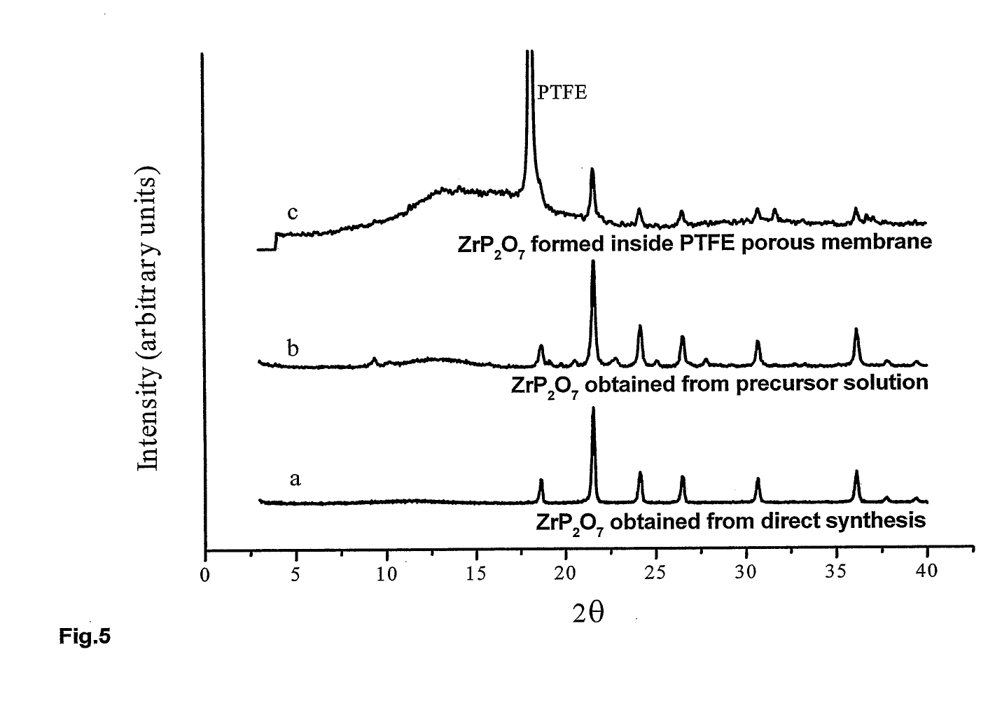

According to a procedure analogous to that described in example 2, a clear solution is prepared. The solvent is at first evaporated at 80° C. and then the residue is heated at 180° C. for one day. The X-ray powder diffraction pattern (see FIG. 5, curve b) shows the formation of zirconium pyrophosphate with a cubic structure.

### Example 3 bis

This example illustrates the detailed preparation of a 3-hexanol solution containing a titanium salt and phosphoric acid from which titanium pyrophosphate of composition TiP₂O₇ is obtained. Some data on the stability of these solutions are also reported.

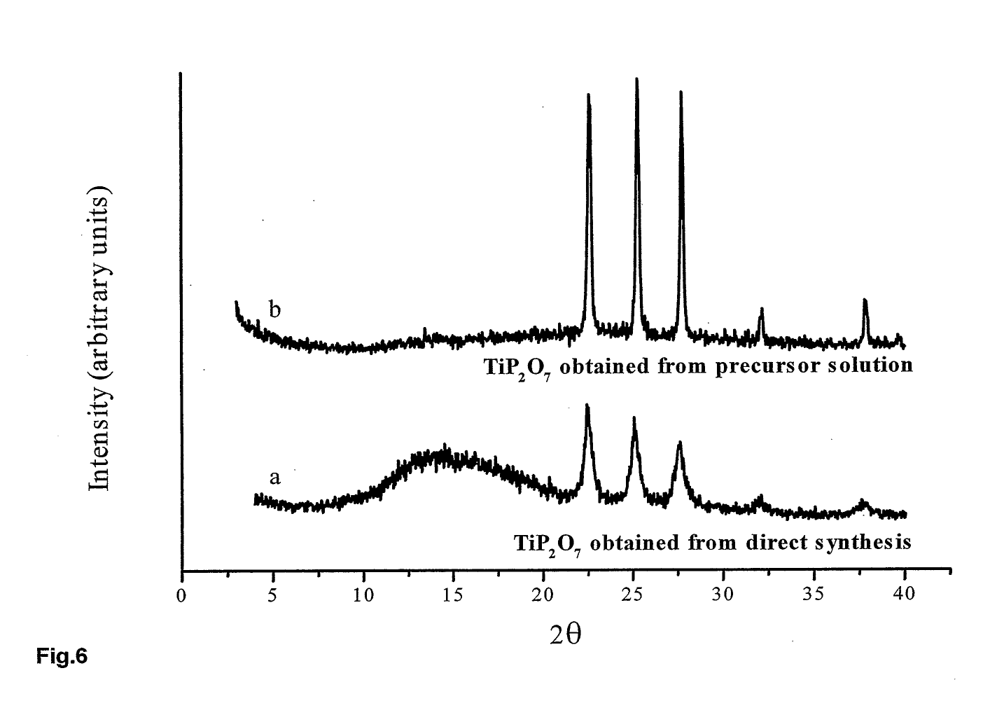

0.144 mol of anhydrous phosphoric acid (14.11 g) are dissolved in 73 mL of 3-hexanol. 6.816 g di titanium propoxide (Aldrich), corresponding to 0.024 mol, are added at 0° C. under stirring to the solution of the phosphoric acid, obtaining a clear solution ([Ti(IV)]=0.3). The solvent is at first evaporated at 80° C. and then the residue is heated at 180° C. for 18 hours. The X-ray powder diffraction pattern (see FIG. 6, curve b) shows the formation of titanium pyrophosphate with a cubic structure.

### Example 4

This example gives a detailed description of the use of the organic solution reported in example 1 to fill the pores of a porous polymeric membrane with zirconium phosphate. Case of a porous polytetrafluoroethylene (PTFE, or Teflon membrane).

A clear DMF solution is prepared according to the procedure described in the example 1. A PTFE membrane (Fluoropore Membrane Filters, Millipore, pore size 0.5 μm; thickness 60 μm; porosity 85%, initial weight 0.0391 g) is completely covered with the solution for about 60 minutes in order to permit a good infiltration of the solution inside the pores. The membrane is taken out from the solution and the liquid excess on the external faces of the membrane is quickly eliminated (e.g., by contacting alternatively the two membrane faces with a paper filter), while the solvent inside the pores is eliminated by drying at 80° C. for about 1 hour and then at 140° C. overnight. The final weight of the membrane is 0.0462 g with a weight increment of 18%. The entire filling procedure can be repeated several times depending on the wished pore filling degree.

### Example 4bis

This example gives a detailed description of the use of the organic solution reported in example 1 to fill the pores of a porous polymeric membrane with hafnium phosphate. Case of a porous polytetrafluoroethylene membrane.

According to the procedure described in the example 2 bis a clear solution with [Hf]=0.1M is prepared.

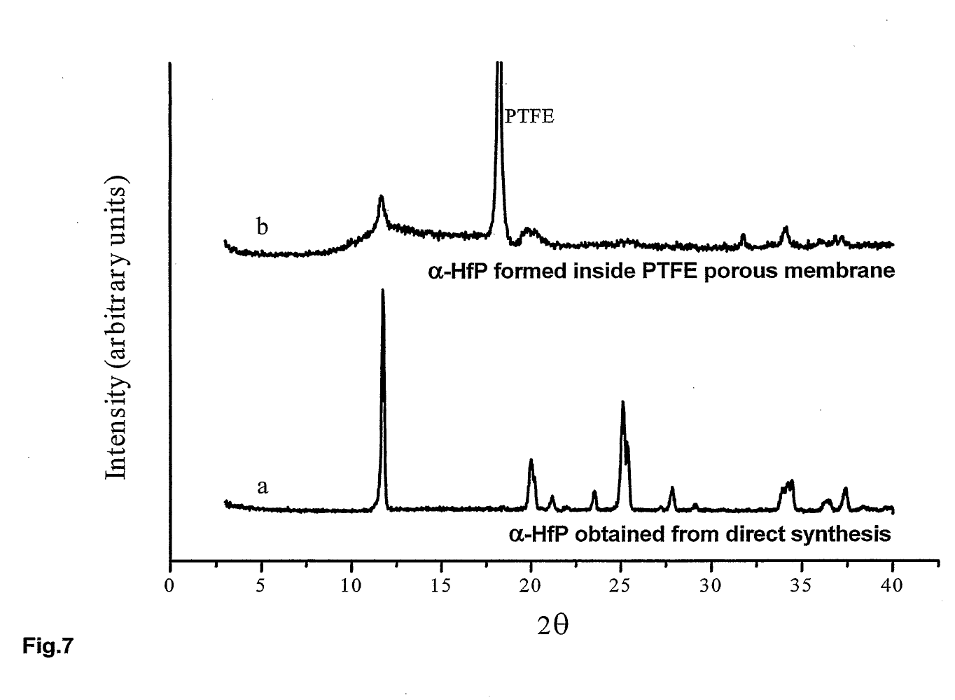

A PTFE membrane is completely covered with the solution at a temperature of 0-3° C., according to the procedure described in the example 4. The weight increment of the membrane is 26 wt %. The X-ray powder diffraction pattern obtained after 10 days of thermal treatment is reported in FIG. 7, curve b. The peak diffraction at 2θ=18° C. is due to the membrane polymer.

### Example 4tris

This example gives a detailed description of the use of the organic solution reported in example 2 to fill the pores of a porous polymeric membrane with zirconium phosphate of composition Hf[O₂P(OH)₂]₂[O₂PO(OH)], HfP₃. Case of a porous polytetrafluoroethylene membrane.

According to the procedure described in the example 2bis, a clear solution with [Hf]=0.1M and [phosphoric acid mol]/[Hf mol]=6 is prepared. A PTFE membrane is completely covered with the solution according to the procedure described in the example 4 bis. The solvent is eliminated at 50-60° C. overnight and then the membrane is maintained at 80° C. to allow the conversion of the inorganic compound into HfP₃ phase. The X ray powder diffraction pattern obtained after 10 days of thermal treatment is reported in FIG. 4, curve c. The peak diffraction at 2θ=18° C. is due to the membrane polymer.

### Example 5

This example gives a detailed description of the use of the organic solution reported in example 3 to fill the pores of a porous polymeric membrane with zirconium. Case of a porous polytetrafluoroethylene membrane.

According to the procedure described in the example 2, a clear solution with [Zr]=0.1M and [phosphoric acid mol]/[Zr mol]=6 is prepared. A PTFE membrane is completely covered with the solution according to the procedure described in the example 4 bis. The solvent is eliminated at 80° C. overnight and then the membrane is left at 180° C. for one day to allow the conversion of the inorganic compound. The X ray powder diffraction pattern obtained after the thermal treatment is reported in FIG. 5, curve c and shows the formation of zirconium pyrophosphate with a cubic structure (compare with FIG. 5, curve a).

### Example 5 bis

This example gives a detailed description of the use of the organic solution reported in example 3 to fill the pores of a porous polymeric membrane with hafnium pyrophosphate of composition HfP₂O₇. Case of a porous polytetrafluoroethylene membrane.

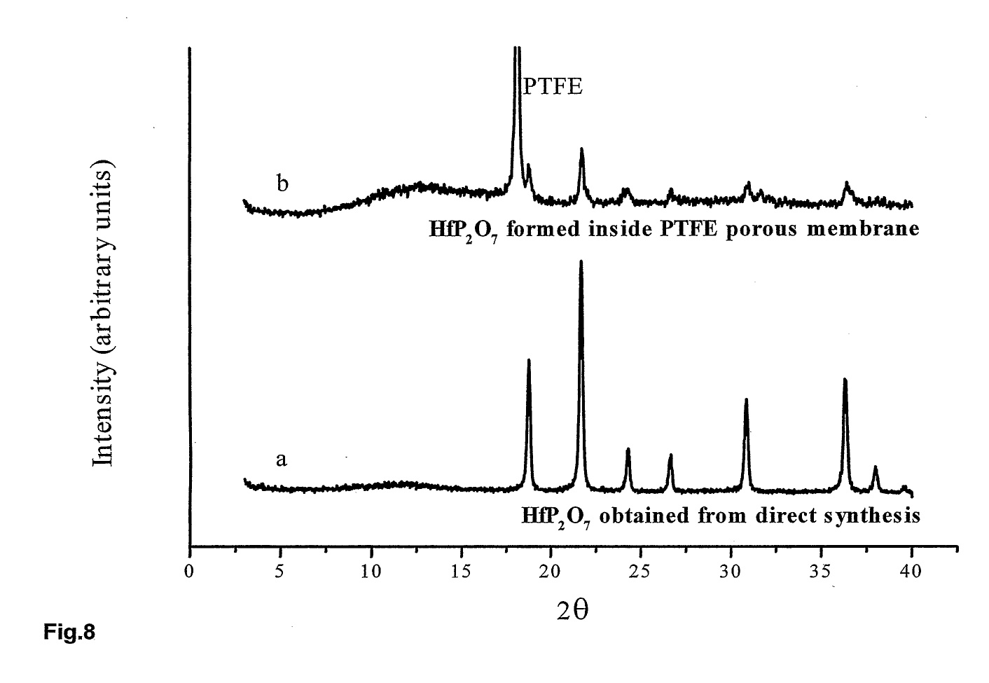

A PTFE membrane is completely covered with the solution prepared according to the procedure described in the example 4 tris, then the membrane is treated as described in the example 5. The X-ray powder diffraction pattern obtained after the thermal treatment is reported in FIG. 8, curve b and shows the formation of hafnium pyrophosphate with a cubic structure.

### Example 6

This example gives a detailed description of the use of the organic solution reported in examples 1-3 or similar, for a partial filling of the pores of a porous inorganic membrane with zirconium phosphates or pyrophosphates in order to prepare a membrane with catalytic properties. Case of a zirconium oxide tubular asymmetrical ceramic membrane filled with particles of Hf[O₂P(OH)₂]₂[O₂PO(OH)]

A zirconium oxide tubular asymmetrical ceramic membrane (TAMI trichannel, thickness of the thin layer 0.14 μm) is out gassed under vacuum in a desiccator. The membrane, kept under vacuum at 0-3° C., is then completely covered with the solution, prepared according to the procedure reported in example 4 tris, for about 10 minutes. The number of the filling steps is chosen in order to have a partial filling of the pores, preferably in the range 30-70 wt %

### Example 7

This example illustrates the use of the organic solutions reported in the examples 1-1tris for preparing a composite membrane consisting of a polymeric matrix of the state of art filled with a given percentage of the wished particles. Case of the sulfonated polyetherketone (s-PEK) filled with 20 wt % particles of zirconium phosphate.

1.0 g of s-PEK (FuMA-Tech 1.4), with ion-exchange capacity 1.4×10⁻³ equivalent/g, previously dehydrated at 80° C. overnight are dissolved in 10 mL of DMF at 120° C. To this solution 1.65 mL of the solution of the example 1 are added. The resulting mixture is kept under stirring for 1 hour at room temperature and then poured on a glass plate. The solvent is evaporated at 80° C. for 5 hours and at 120-130° C. for 2 hours. The membrane is then detached from the glass support by immersion in water, washed with diluted HCl solution, washed with a mixture 1:1 v/v of ethanol/water and stored at room temperature. The percentage of zirconium phosphate in the anhydrous membrane is 20 wt % and the membrane thickness is 0.008 cm.

### Example 7 bis

This example illustrates the use of the organic solutions reported in the examples 1-1tris for preparing a composite membrane consisting of a polymeric matrix of the state of art filled with a given percentage of the wished particles. Case of the Fumion filled with 10 wt % particles of zirconium phosphate.

1.0 g of Fumion (perfluorinated polysulfonic acid, FuMA-Tech), with ionexchange capacity 0.9×10⁻³ equivalent/g, previously dehydrated at 80° C. overnight are dissolved in 10 mL of DMF at 80° C. To this solution 0.8 mL of the solution of the example 1 are added. The resulting mixture is kept under stirring for 1 hour at room temperature and then poured on a glass plate. The solvent is evaporated at 80° C. for 5 hours and at 120-130° C. for 2 hours. The membrane is then detached from the glass support by immersion in water, washed with diluted HCl solution, washed with a mixture 1:1 v/v of ethanol/water and stored at room temperature. The percentage of zirconium phosphate in the anhydrous membrane is 10 wt % and the membrane thickness is 0.008 cm.

### Example 7 tris

This example illustrates the use of the organic solutions reported in the examples 2-2 bis for preparing a composite membrane consisting of a polymeric matrix of the state of art filled with a given percentage of the wished particles. Case of the Fumion filled with 16.5 wt % particles of hafnium phosphate.

0.217 g of anhydrous Fumion are dissolved in 8 mL of a mixture 1:1 v/v of 3-hexanol/1-propanol at 40° C. for about 4 hours.

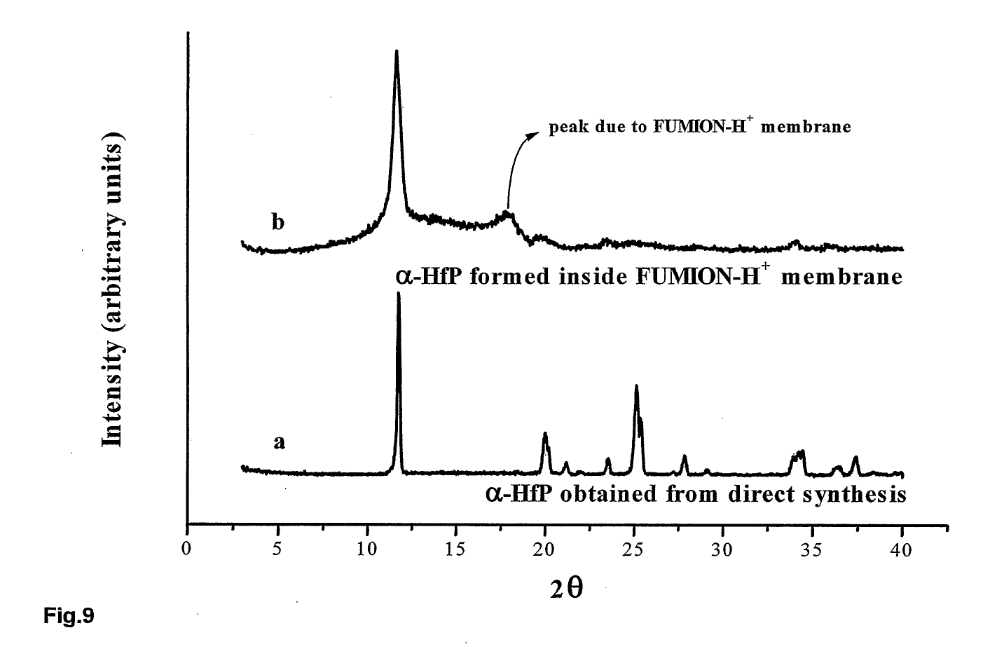

According to the procedure described in example 2 bis, a clear solution with [Hf]=0.1 M and [phosphoric acid mol]/[Hf mol]=6 is prepared. 1.16 mL of this solution are added at room temperature and under stirring to the polymer solution. The resulting mixture is kept under stirring for 1 hour at room temperature and then poured on a glass plate. The solvent is evaporated at 55° C. overnight and at 80° C. for 2 days and then the membrane is directly detached from the glass support without using any solvent. The percentage of hafnium phosphate in the anhydrous membrane is 16.5 wt %. The X-ray powder diffraction pattern is reported in FIG. 9, curve b.

### Example 8

This example illustrates the use of the organic solutions reported in the examples 2-2 bis for preparing a composite membrane consisting of a polymeric matrix of the state of art filled with a given percentage of the wished particles. Case of the Fumion filled with 30 wt % particles of Hf[O₂P(OH)₂]₂[O₂PO(OH)].

0.217 g of anhydrous Fumion are dissolved in 8 mL of a mixture 1:1 v/v of 3-hexanol/1-propanol at 40° C. for about 4 hours.

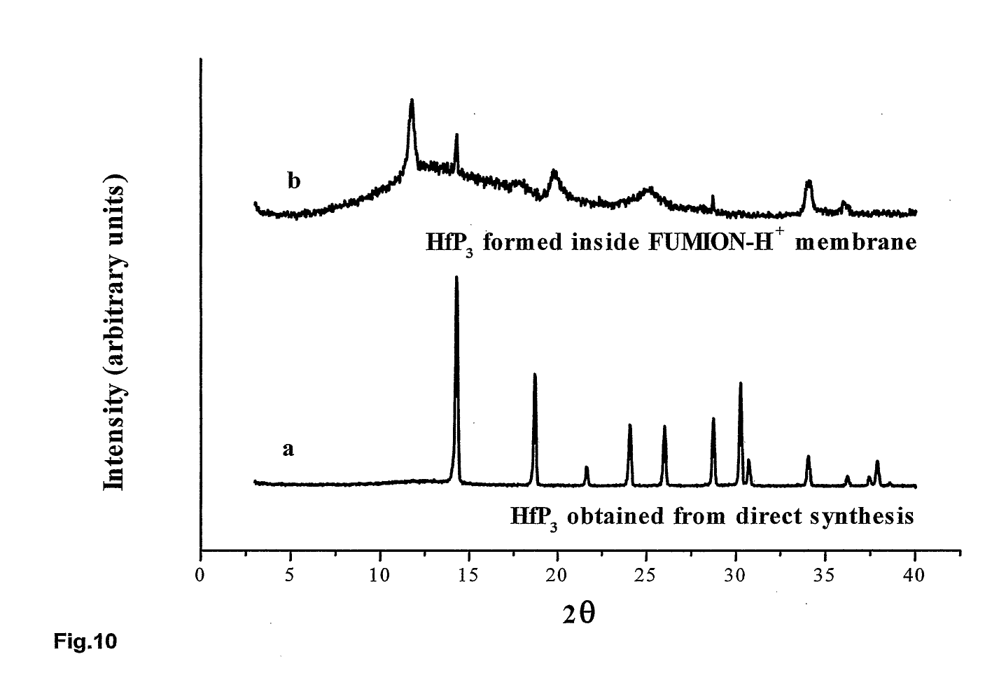

According to the procedure described in example 2 bis, a clear solution with [Hf]=0.1 M and [phosphoric acid mol]/[Hf mol]=10 is prepared. 1.98 mL of this solution are added at room temperature and under stirring to the polymer solution. The resulting mixture is kept under stirring for 1 hour at room temperature and then poured on a glass plate. The solvent is evaporated at 55° C. overnight and at 80° C. for 3 days and then the membrane is directly detached from the glass support. The percentage of Hf[O₂P(OH)₂]₂[O₂PO(OH)] in the anhydrous membrane is 30 wt %. The X-ray powder diffraction pattern is reported in FIG. 10, curve b.

### Example 9

This example illustrates the use of the organic solutions reported in the examples 2-2 bis for preparing a composite membrane consisting of a polymeric matrix of the state of art filled with a given percentage of wished particles. Case of the Fumion filled with 16 wt % particles of cubic hafnium pyrophosphate.

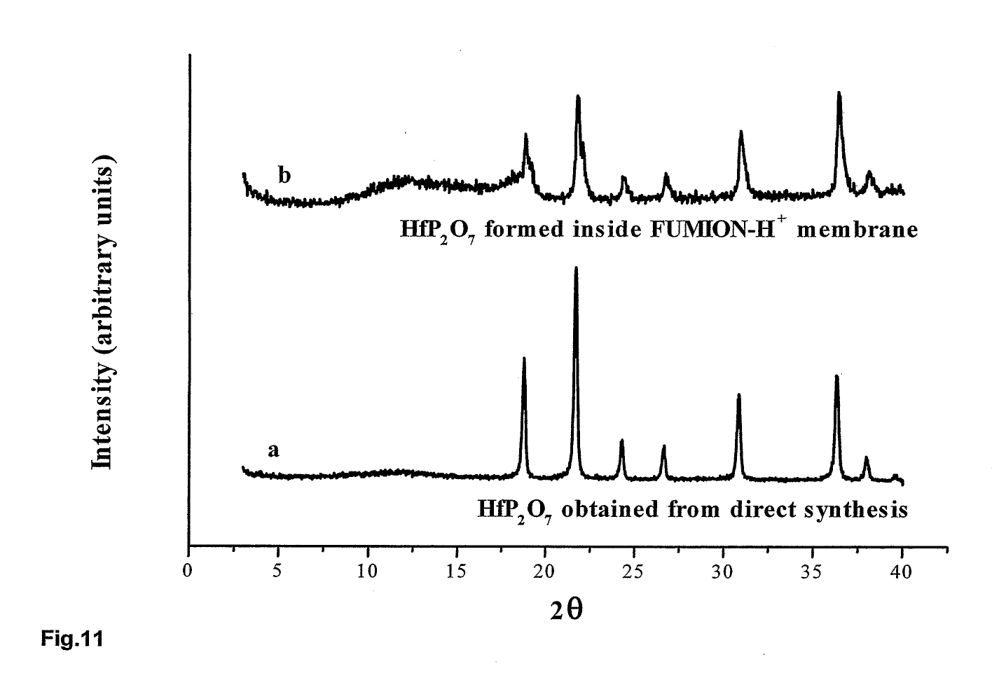

According to the procedure described in example 7 tris a composite membrane is prepared. After thermal treatment of the membrane at 120° C. for 2 hours and 180° C. overnight a composite membrane containing 16 wt % of HfP₂O₇ is obtained. The X-ray powder diffraction pattern is reported in FIG. 11, curve b.

### Example 10

This example illustrates the use of the organic solutions reported in the examples 1-1tris, to insert inorganic particles in the interface regions electrodes/membrane; case of Hf(O₃POH)₂.

According to the procedure described in example 1 bis a clear solution of the precursor of α-HfP in DMF is prepared. The solution is directly sprayed on the gas diffusion electrode surface (e.g. an ELAT™ electrode by De Nora North America). The solvent is at first evaporated by thermal treatment at 80° C. for about 30 minutes and then completely eliminated by thermal treatment at 140-150° C. for 5-6 hours.

### Example 10 bis

This example illustrates the use of the organic solutions reported in the examples 2-2tris, to insert inorganic particles in the interface regions electrodes/membrane; case of HfP₃.

According to the procedure described in example 2 bis a clear solution of the precursor of HfP₃ in 3-hexanol is prepared. The solution is directly sprayed on the gas diffusion electrode surface. The solvent is at first evaporated by thermal treatment at 80° C. for about 30 minutes and then completely eliminated by thermal treatment at 120-130° C. for 5-6 hours.

### Example 10 tris

This example illustrates the use of the organic solutions reported in the examples 3-3bis, to insert inorganic particles in the interface regions electrodes/membrane; case of cubic titanium pyrophosphate.

According to the procedure described in example 3 bis a clear solution of the precursor of TiP₂O₇ in 3-hexanol is prepared. The solution is directly sprayed on the gas diffusion electrode surface. The solvent is evaporated by thermal treatment at 170-180° C. for 6-7 hours. The excess of phosphoric acid is removed by washing the electrode with ethanol. The residues of ethanol are finally removed by evaporation.

### Example 11

This example illustrates the use of the organic solutions reported in the examples 1-3, to insert inorganic particles in the interface regions electrodes/membrane; case of α-HfP in Nafion.

According to the procedure described in example 1 bis a clear solution of the precursor of α-HfP in DMF is prepared. 0.15 mL of this solution are added, under stirring to 10 g of Nafion solution (5 wt % in alcoholic solution by Aldrich). The solution is directly sprayed or painted on the gas diffusion electrode surface. The solvent is at first evaporated by thermal treatment at 80° C. for about 30 minutes and then completely eliminated by thermal treatment at 130-140° C. for 5-6 hours.

### Example 11 bis

This example illustrates the use of the organic solutions reported in the examples 1-3, to insert inorganic particles in the interface regions electrodes/membrane; case of cubic zirconium pyrophosphate in Nafion

According to the procedure described in example 3, a clear solution of the precursor of ZrP₂O₇ in 3-hexanol is prepared. 0.2 mL of this solution are added, under stirring to 10 g of Nafion solution. The solution is directly sprayed or painted on the gas diffusion electrode surface. The solvent is at first evaporated by thermal treatment at 80° C. for about 30 minutes and then completely eliminated by thermal treatment at 170-180° C. for 5-6 hours. The excess of phosphoric acid is removed by washing the electrode with ethanol. The residues of ethanol are finally removed by evaporation.

As reported before, the preparation of gels of zirconium phosphate in organic solvents with a procedure based on the exfoliation of pre-formed microcrystals of this proton conductor, has been already reported in the PCT patent No. WO 03/077340 A2.

It was now found that similar gels of zirconium and hafnium phosphates in organic solvents can be directly obtained by the precursor solutions with an easier procedure.

As reported before, the quick formation of dense gels is observed when the precursor solutions are warmed at temperatures higher than 30-40° C. The exact nature of these gels is at the moment unknown. Taking into account that insoluble M(/IV) phosphates are obtained after elimination of the solvent, it is likely that these gels are constituted by small clusters of layered M(IV) phosphates. Since the number of species present along borders of very small layered particles can be a significant fraction of the total species, edge-edge interactions among these particles could be preferred to surface-surface interactions. In this case, the gels could be seen as house-card arrangements of very small particles, with the organic solvent trapped between them. When the solvent is eliminated, the instability of said house-card arrangement could lead to layered arrangements of the planar particles. Since the formation of these gels is obtained in times relatively short, the size of the layer particles is expected to be even smaller than that of particles obtained by exfoliation of pre-formed M(IV) phosphates. In any case, although additional studies have to be carried out to better clarify the nature of these gels and the exact size of the particles, the easy and economical preparation as well as the stability even long time after their preparation is of great practical importance for the preparation of composite proton conducting membranes.

### Example 12

This example illustrates the use of precursor solutions with molar ratio (H₃PO₄/Zr=2) to prepare a stable zirconium phosphate-DMF gel. A precursor DMF solution of zirconium phosphate of α-type is first prepared as reported in the example 1.

The precursor solution is heated at 80° C. for 30 min. The formation of a compact and transparent gel of zirconium phosphate containing a large amount of trapped DMF is obtained. In the experimental conditions used in this example the wt/wt % of zirconium phosphate is 12%. This gel can be conserved in closed vessels and used even after for a very long time from its preparation.

### Example 12 bis

This example illustrates the use of precursor solutions with molar ratio (H₃PO₄/Hf=2) to prepare a hafnium phosphate-DMF gel.

A precursor DMF solution of hafnium phosphate of α-type is first prepared as reported in the example 1 bis.

The precursor solution is heated at 80° C. for 30 min. The formation of a compact and transparent get of hafnium phosphate containing a large amount of trapped DMF is obtained. In the experimental conditions used in this example the wt/wt % of hafnium phosphate is 15%. This gel can be conserved in closed vessels and used even after for a very long time from its preparation.

### Example 12 tris

This example illustrates the use of precursor solutions with molar ratio H₃PO₄/HF=3 to prepare a stable hafnium phosphate-DMF gel.

A precursor DMF solution of hafnium phosphate of a α-type is first prepared as reported in the example 1bis with the molar ratio H₃PO₄/Hf in this solution=3.

The precursor solution is heated at 80° C. for 30 min. The formation of a compact and transparent gel of hafnium phosphate containing a large amount of trapped DMF is obtained. Since in this case the used ratio H₃PO₄/Hf ration was 3, an excess of phosphoric acid remains in the DMF gels. This excess of phosphoric acid can be eliminated by washing the gel two or three times with DMF.

In the experimental conditions used in this example the wt/wt % of hafnium phosphate is 20%. This gel can be conserved in closed vessels and used even after for a very long time from its preparation.

### Example 13

This example illustrates the use of gel reported in the example 12 to prepare a composite Fumion membrane filled with nano particles of zirconium phosphate)

A weighed amount of Fumion (corresponding to 1 g of anhydrous ionomer) is dissolved under vigorous stirring in 8 g of DMF at 80° C. To this solution, 0.44 g of the gel of the example 12 are added. The mixture is held under stirring at room temperature for 1 hour and then poured on a glass plate. The solvent is evaporated at 80° C. for 5 hours and at 120-130° C. for 2 hours. The membrane is then detached from the glass support by immersion in water, washed with diluted HCl solution, washed with a mixture 1:1 v/v of ethanol/water and stored at room temperature. The percentage of zirconium phosphate in the anhydrous membrane is 5% and the membrane thickness is 0.006 cm.

### Example 13 bis

This example illustrates the use of gel reported in the example 12bis to prepare a composite Fumion membrane filled with nano particles of hafnium phosphate)

A weighed amount of Fumion (corresponding to 1 g of anhydrous ionomer) is dissolved under vigorous stirring in 8 g of DMF at 80° C. To this solution, 0.35 g of the gel of the example 12bis are added. The mixture is held under stirring at room temperature for 1 hour and then poured on a glass plate. The solvent is evaporated at 80° C. for 5 hours and at 120-130° C. for 2 hours. The membrane is then detached from the glass support by immersion in water, washed with diluted HCl solution, washed with a mixture 1:1 v/v of ethanol/water and stored at room temperature. The percentage of hafnium phosphate in the anhydrous membrane is 5% and the membrane thickness is 0.008 cm.

1-31. (canceled)

32. An organic solution containing tetravalent metal salts, phosphoric acid, and an organic solvent,
wherein after evaporation of the organic solvent, at least one insoluble compound selected from the group consisting of M(IV)(O₃P—OH)₂, M(IV)[O₂P(OH)₂]₂[O₂PO(OH)], and M(IV)P₂O₇, where M(IV) is a tetravalent metal, can be directly obtained.

33. The organic solution according to claim 32, wherein the tetravalent metal comprises an anion selected from the group consisting of carboxylates, chlorides, and alcoxides.

34. The organic solution according to claim 32, wherein the tetravalent metal is selected from the group consisting of Zr, Hf, Ti, and mixtures thereof.

35. The organic solution according to claim 32, wherein the tetravalent metal salts are selected from the group consisting of zirconyl propionate, zirconyl chloride, hafnium oxide-propionate, hafnium oxidechloride, hafnium-tetrachloride, and titanium alcoxide.

36. The organic solution according to claim 32, wherein the organic solvent is a basic solvent.

37. The organic solution according to claim 32, wherein the organic solvent is commonly used for dissolving proton conducting ionomers and is selected from the group consisting of N-methyl 2-pyrrolidone, N,N-dimethylacetamide, N,N-dimethylformamide, dimethylsulfoxide, dioxane, tetrahydrofurane, acetonitrile, alkanols with at least four carbon atoms, and mixtures thereof.

38. The organic solution according to claim 32, wherein the organic solvent is at least one aprotic dipolar solvent.

39. The organic solution according to claim 38, wherein the organic solvent is selected from the group consisting of N-methyl 2-pyrrolidone, N,N-dimethylacetamide, N,N-dimethylformamide, and dimethylsulfoxide.

40. A method for easily inserting at least one insoluble compound having a composition selected from the group consisting of M(IV)(O₃P—OH)₂, M(IV)[O₂P(OH)₂]₂[O₂PO(OH)], and M(IV)P₂O₇ inside pores of polymeric or inorganic porous membranes, comprising:
a) impregnation of the porous membranes with a solution according to claim 32;
b) elimination of the solvent; and
c) repetition of a) and b) until the desired percentage of pore filling is obtained.

41. The method according to claim 40, wherein the at least one insoluble compound is in the form of nano-particles.

42. A method for the filling of porous membranes with insoluble tetravalent metal acid phosphates selected from the group consisting of M(IV)(O₃P—OH)₂, M(IV)[O₂P(OH)₂]₂[O₂PO(OH)], and insoluble pyrophosphates M(IV)P₂O₇, comprising:
a) impregnating the porous membranes with the organic solution according to claim 32;
b) eliminating the solvent; and
c) repeating of the steps a) and b) until the wished percentage of pore filling is obtained.

43. The method according to claim 42, wherein a greater part of the solvent elimination is performed by evaporation at lower temperatures while transformation into the final insoluble compound is completed at higher temperatures.

44. The method according to claim 43, wherein a greater part of the solvent elimination is performed by evaporation at 60 to 70° C. while transformation into the final insoluble compound is completed at temperatures of 75-100° C. for M(IV)[O₂P(OH)₂]₂[O₂PO(OH)], 130-140° C. for M(IV)(O₃P—OH)₂, and 140-180° C. for M(IV) P₂O₇.

45. A method of preparing nano-polymers in which nano-particles of at least one insoluble compound having a composition selected from the group consisting of M(IV)(O₃P—OH)₂, M(IV)[O₂P(OH)₂]₂[O₂PO(OH)], and M(IV) P₂O₇, are dispersed inside matrices of organic or inorganic polymers soluble in an organic solvent, comprising:
a) using an organic solution of claim 32 and containing, at the same time, a polymer of the state of the art; and
b) eliminating the solvent.

46. The method according to claim 45, wherein the organic polymeric matrix is that of a proton conducting ionomer.

47. A method of preparing nano-polymers in which nano-particles of at least one insoluble compound having a composition selected from the group consisting of M(IV)(O₃P—OH)₂, M(IV)[O₂P(OH)₂]₂[O₂PO(OH)], and M(IV)P₂O₇, are dispersed inside matrices of organic or inorganic polymers soluble in an organic solvent, comprising:
a) using an organic solution of claim 32 and containing, at the same time, ionomer of the state of the art; and
b) eliminating the solvent.

48. A method for the preparation of the nano-polymers of claim 45, wherein the solvent elimination is carried out by solvent evaporation or with a non-solvent of the polymer.

49. A method for the preparation of the nano-ionomers of claim 47, wherein the solvent elimination is carried out by solvent evaporation or with a non-solvent of the ionomer.

50. Nano-polymers constituted by particles selected from the group consisting of M(IV)(O₃P—OH)₂, M(IV)[O₂P(OH)₂]₂[O₂PO(OH)] and M(IV)P₂O₇,
wherein the particles are dispersed in matrices of organic or inorganic polymers.

51. The nano-polymers according to claim 50, wherein the particles are nano-particles.

52. The nano-polymers according to claim 50, wherein at least one matrix is that of a ionomer of the state of the art.

53. The nano-polymers according to claim 52, in which the ionomer is selected from the group consisting of perfluorocarboxysulfonic, sulfonated poly-ether-ketone, and sulfonated poly-ether-sulfones.

54. A method for the preparation of membranes constituted by nanopolymers constituted by particles selected from the group consisting of M(IV)(O₃P—OH)₂, M(IV)[O₂P(OH)₂]₂[O₂PO(OH)], and M(IV)P₂O₇, dispersed in matrices of organic or inorganic polymers comprising:
a) preparing or using an organic solution of claim 32 and containing, at the same time, a polymer or a ionomer of the state of the art;
b) using the organic solution for the preparation of a nano-polymeric membrane by any known procedure of the state of the art such as the method known as casting procedure; and
c) eliminating of the organic solvent.

55. A method for easily inserting at least one nano-particle compound selected from the group consisting of M(IV)(O₃P—OH)₂, M(IV)[O₂P(OH)₂]₂[O₂PO(OH)], and M(IV)P₂O₇ in the electrode/membrane interface of PEM FCS, comprising:
a) impregnation of the electrode/membrane interface of PEM FCS with a solution according to claim 32;
b) elimination of the solvent; and
c) repetition of a) and b) until the desired percentage of pore filling is obtained.

56. A method for easily inserting at least one insoluble compound selected from the group consisting of M(IV)(O₃P—OH)₂, M(IV)[O₂P(OH)₂]₂[O₂PO(OH)], and M(IV)P₂O₇ in the polymers usually sprayed on electrode/membrane interfaces of PEM FCS, comprising:
a) impregnation of the electrode/membrane interfaces of PEM FCS with a solution according to claim 32 and at least one compound selected from the group consisting of ionomers and other proton conducting compounds soluble in an organic solvent;
b) elimination of the solvent; and
c) repetition of a) and b) until the desired percentage of pore filling is obtained.

57. The method according to claim 56, wherein the insoluble compounds are in the form of nano-particles.

58. Composite proton conducting membranes comprising porous membranes (polymeric or inorganic) with pores filled by the compound M(IV)[O₂P(OH)₂]₂[O₂PO(OH)] or with a mixture of said compound and a proton conducting ionomer,
wherein the composite proton conducting membranes are obtained making use of the organic solutions of claim 32.

59. Composite membranes comprising porous membranes, polymeric or inorganic, with pores partially filled with the compounds of claim 32 or mixtures thereof.

60. Proton conducting nano-ionomeric membranes comprising the nano-polymers of claim 50.

61. A catalytic membrane reactor comprising the composite membrane of claim 59.

62. An electrochemical device comprising the membrane of claim 58.

63. An electrochemical device planned for generating electrical energy from the oxidation of a fuel, comprising the membranes of claim 58.

64. An electrochemical device planned for generating electrical energy from the oxidation of a fuel, comprising the membranes of claim 59.

65. Fuel cells specifically planned for electrical vehicles and for portable electrical devices, comprising the membranes of claim 63.

66. Fuel cells specifically planned for electrical vehicles and for portable electrical devices, comprising the membranes of claim 64.

67. A method for improving the global performance of ionomeric membranes of the state of the art in hydrogen, indirect methanol and direct methanol fuel cells, comprising using the membranes of claim 58.

68. A method for improving the global performance of ionomeric membranes of the state of the art in hydrogen, indirect methanol and direct methanol fuel cells, comprising using the membranes of claim 59.

69. PBI membranes modified with precursor solutions of tetravalent metal acid phosphates selected from the group consisting of M(IV)(O₃P—OH)₂, M(IV)[O₂P(OH)₂]₂[O₂PO(OH)], and M(IV)P₂O₇.

70. PBI+phosphoric acid membranes modified with precursor solutions of tetravalent metal acid phosphates selected from the group consisting of M(IV)(O₃P—OH)₂, M(IV)[O₂P(OH)₂]₂[O₂PO(OH)], and M(IV)P₂O₇.

71. Organic gels containing tetravalent metal salts and phosphoric acid, wherein after solvent evaporation, at least one of the insoluble compounds having a composition selected from the group consisting of M(IV)(O₃P—OH)₂, M(IV)[O₂P(OH)₂]₂[O₂PO(OH)] and M(IV)P₂O₇, where M(IV) is a tetravalent metal, can be directly obtained.

72. A method for the preparation of the organic gels of claim 71 comprising:
heating organic solutions containing tetravalent metal salts and phosphoric acid from which, after solvent evaporation, at least one of the insoluble compounds has a composition selected from the group consisting of M(IV)(O₃P—OH)₂, M(IV)[O₂P(OH)₂]₂[O₂PO(OH)], and M(IV)P₂O₇, where M(IV) is a tetravalent metal, can be directly obtained.
